(19) United States
(12) Patent Application Publication
(10) Pub. No.: US 2009/0041953 A1
(43) Pub. Date: Feb. 12, 2009

(54) Method for depositing a metallic substrate on a wall

(75) Inventors: Scarlett Fajardo-Reina, Ratingen (DE); Birgit Gruger, Dortmund (DE); Karl-Heinz Gunzelmann, Nurnberg (DE); Wolfgang Janssen, Heiligenhaus (DE); Karsten Niepold, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 12/156,594

(22) Filed: Jun. 2, 2008

(30) Foreign Application Priority Data
Jun. 13, 2007 (EP) 07011625.6

(51) Int. Cl. H05H 1/48

(52) U.S. Cl. 427/580

(57) ABSTRACT

In one aspect, a method for depositing a metallic substrate on a wall of a narrow depression of a metallic component is provided. A wire electrode is introduced into the depression and thereby bent in the direction of the wall by means of a guide. A suitable voltage is applied to the component and to the wire electrode in order to create an arc, which melts the wire electrode in certain regions. The molten material of the wire electrode is thereby deposited on the wall of the component. The wire electrode is progressively fed in during the depositing operation.

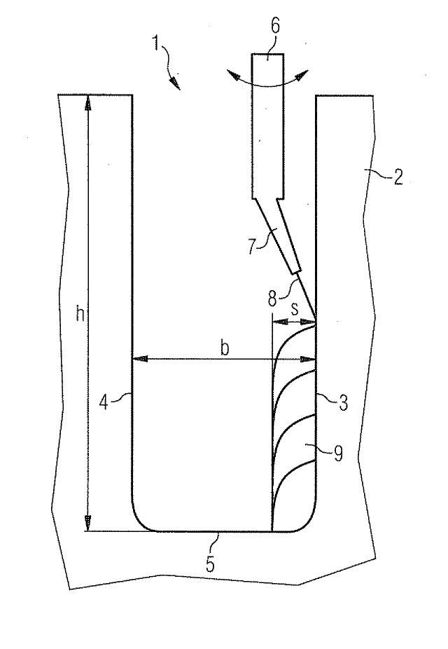

### CROSS REFERENCE TO RELATED APPLICATIONS

This application claims priority of European Patent Office application No. 07011625.5 EP filed Jun. 13, 2007, which is incorporated by reference herein in its entirety.

### FIELD OF INVENTION

The invention relates to a method for depositing a metallic substrate on a wall of a narrow depression of a metallic component.

### BACKGROUND OF INVENTION

Metallic components have depressions that are often narrow, for example in the form of grooves. If the wall of such a groove becomes damaged by wear, locally limited repair is scarcely possible. In particular, it is therefore not possible to use standard welding methods to apply a weld metal in the region under repair, since the constricted space in the narrow gap of the groove does not allow them to be used. Therefore, at present the entire region of the groove to be repaired has to be built up by welding and the groove subsequently made once again. This is laborious and expensive.

### SUMMARY OF INVENTION

To prevent damage to the wall of the narrow depression from the outset, it is also desirable to apply wear protection in this region. This may take the form of applying metals that can withstand high thermal, chemical and/or mechanical loads to the wall. However, the welding methods that are known in the prior art also not suitable for this for the reasons explained above.

It is therefore the object of the present invention to provide a method of the type stated at the beginning with the aid of which a wall of a narrow depression in a metallic component can be repaired by depositing a metallic substrate. Furthermore, it is intended to make it possible to apply wear protection to a wall in a narrow depression of a metallic component.

These objects are achieved according to the invention by a wire electrode being introduced into the depression and thereby bent in the direction of the wall by means of a guide, and by applying a suitable voltage to the component and to the wire electrode in order to create an arc, which melts the wire electrode in certain regions, the molten material of the wire electrode being deposited on the wall of the component and the wire electrode being progressively fed in during the depositing of the metallic substrate.

The basic idea of the invention is therefore first to introduce a wire electrode into the depression and bend it in the direction of the wall to which the metallic substrate is to be deposited by means of a guide. Then, a suitable voltage is applied to the component and to the wire electrode to create an arc. The arc melts the wire electrode in certain regions and the molten material of the wire electrode is deposited on the wall of the component. To replace the melted region of the wire electrode, the wire electrode is progressively fed in during the depositing of the metallic substrate.

The advantage of the method according to the invention is that metallic substrate can be deposited even on a wall of a narrow depression. At the same time, adequate and reproducible side wall fusion is ensured. Furthermore, depositing of the metallic substrate is possible in a wide variety of positions, i.e. for example on vertical and horizontal side walls.

According to a first embodiment, it is provided that at least the wire electrode in the arc is surrounded by a shielding gas. In this way it is ensured that neither the wall nor the wire electrode is undesirably oxidized in the region of the arc.

It is likewise possible to use a wire electrode that consists of the same metal as the component or a metal of a similar type. It is advantageous in particular if a wall of a narrow depression in a metallic component is to be repaired. In this case it is possible to use either a wire electrode that consists of the same material as the component to be repaired or a wire electrode that consists of a material of a similar type to that of the metal of the component. In any event, it is ensured that the metallic substrate newly deposited on the wall has similar properties to those of the metal of the component.

Alternatively, a wire electrode of a metal that can withstand high thermal, chemical and/or mechanical loads may be used. In this way, wear protection can be easily applied to the wall of the narrow depression. At the same time, the metal of the wire electrode differs from that of the component in that it has altogether a greater resistance to thermal, chemical and/or mechanical loads.

According to a further embodiment of the invention, it is envisaged to use a solid wire or a tubular wire as the wire electrode.

A development of the invention provides that the wire electrode is moved away from the wall and toward it in an oscillating motion during the depositing of the metallic substrate.

To check the position of the wire electrode with respect to the wall, and correct it if need be, the current and/or voltage variation occurring during the creation of the arc may be correlated with the oscillating motion of the wire electrode. This allows the arc to be used almost as a sensor for the position of the wire electrode with respect to the wall. For instance, at defined oscillating positions, for example when the wire electrode is particularly close to the wall, the current variation and/or the voltage variation change significantly. A set/actual comparison can then be performed and a correction of the distance of the wire electrode from the wall carried out if need be.

It is likewise possible to deposit the metallic substrate on the wall of a gap, groove or bore.

According to the invention, the metallic substrate may also be deposited on a groove in a casing component of a gas turbine.

### BRIEF DESCRIPTION OF THE DRAWINGS

The invention is explained in more detail below on the basis of an exemplary embodiment with reference to the drawing.

In the drawing, the single FIGURE shows a schematic representation of a narrow depression in a component while the method according to the invention is being carried out.

### DETAILED DESCRIPTION OF INVENTION

A narrow depression 1 in a metallic component 2 is represented in the FIGURE. The narrow depression 1 may be, for example, a groove on a casing component of a gas turbine.

The depression 1 is defined by two lateral walls 3, 4 and a bottom wall 5. It has a width b and a depth h, the ratio of which is such that use of customary welding techniques is not possible for depositing a metallic substrate on one of the walls 3, 4, 5.

Arranged in the depression 1 is a welding head 6, which has a guide 7, to bend a wire electrode 8 that has been introduced into the depression 1 through the welding head 6 in the direction of the lateral wall 3. A suitable welding head is described, for example, in DE 32 20 242 C2. The wire electrode consists here of a material that can withstand high thermal, chemical and/or mechanical loads.

To apply wear protection to the lateral wall 3 with the aid of the method according to the invention, the wire electrode 8 is introduced into the depression 1 through the welding head 6 and the guide 7 until the end of the wire electrode 8 is arranged at a suitable distance from the lateral wall 3. Then, such a voltage that an arc is ignited between the lateral wall 3 and the wire electrode 8 is applied to the metallic component 2 and the wire electrode 8. The arc is not represented in the drawing, but is carried by the wire electrode 8, so that the latter melts in certain regions. The molten material of the electrode 8 is deposited on the lateral wall 3 as metallic substrate 9.

During the depositing operation, the welding head 6 may perform an oscillating motion away from the lateral wall 3 and toward it, as represented by the arrow in the drawing. As a result of this oscillating motion, the metallic substrate 9 is deposited with a width S on the lateral wall 3 in the form of an oscillated bead. Alternatively, the metallic substrate 9 may be deposited on the lateral wall 3 in a number of layers one on top of the other or else as an unoscillated bead. During the depositing, the wire electrode 8 that is melting in certain regions is progressively fed in.

To check the position of the wire electrode 8 with respect to the lateral wall 3 during the depositing process, and correct it if need be, the current and/or voltage variation occurring during the creation of the arc may be correlated with the oscillating motion of the wire electrode 8. So, depending on the distance between the wire electrode 8 and the lateral wall 3, different current or voltage variations occur, from which conclusions as to the position of the wire electrode 8 in relation to the lateral wall 3 can be drawn by an actual/set comparison. If deviations from a predetermined path are established here, the position of the wire electrode 8 or of the welding head 6 can be adapted.

Oxidation of the metallic components in the depression 1 can be prevented by the latter being filled with a shielding gas.

It is likewise possible alternatively to use a wire electrode 8 of a metal that is of a similar type or identical to the metal of the component 2. This is advantageous in particular whenever instances of damage to the lateral wall 3 are to be repaired.

The advantage of the method according to the invention is that the metallic substrate 9 can be deposited on the wall 3 of the narrow depression 1. In this way it is easily possible to carry out cladding with wear protection and similarly repair of the wall 3.

1.-9. (canceled)

10. A method for depositing a metallic substrate on a wall of a narrow depression of a metallic component, comprising:
introducing a wire electrode into the depression via a guide;
bending the wire in the direction of the wall via the guide;
applying a voltage to the component and to the wire electrode in order to create an arc such that the voltage melts the wire electrode in regions; and
depositing molten material of the melted wire electrode on the wall of the component,
wherein the wire electrode is progressively fed into the depression during the depositing of the metallic substrate, and
wherein the width of the depression is greater than the width of the substrate created on the wall.

11. The method as claimed in claim 10, wherein at least the wire electrode in the arc is surrounded by a shielding gas.

12. The method as claimed in claim 10, wherein the wire electrode comprises a metal similar to the metal of the component.

13. The method as claimed in claim 12, wherein the wire electrode consists of the same metal as the component.

14. The method as claimed in claim 10, wherein a metal of the wire electrode withstands high thermal, chemical and mechanical loads.

15. The method as claimed in claim 10, wherein a metal of the wire electrode withstands high thermal loads.

16. The method as claimed in claim 10, wherein a metal of the wire electrode withstands high chemical loads.

17. The method as claimed in claim 10, wherein a metal of the wire electrode withstands high mechanical loads.

18. The method as claimed in claim 10, wherein the wire electrode is a solid wire or a tubular wire.

19. The method as claimed in claim 10, wherein the wire electrode is moved away from the wall and toward the wall in an oscillating motion during the depositing of the metallic substrate.

20. The method as claimed in claim 19, wherein a current variation and a voltage variation occurring during the creation of the arc is correlated with the oscillating motion of the wire electrode, in order to check the position of the wire electrode with respect to the wall and make corrections when needed.

21. The method as claimed in claim 19, wherein a current variation or a voltage variation occurring during the creation of the arc is correlated with the oscillating motion of the wire electrode, in order to check the position of the wire electrode with respect to the wall and make corrections when needed.

22. The method as claimed in claim 10, wherein the metallic substrate is deposited on the wall of a gap, groove or bore.

23. The method as claimed in claim 22, wherein the metallic substrate is deposited on a groove in a casing component of a gas turbine.
